(19) United States
(12) Patent Application Publication
(10) Pub. No.: US 2024/0165604 A1
(43) Pub. Date: May 23, 2024

(54) MEASUREMENT SYSTEM, ANALYSIS PROGRAM AND MEASUREMENT METHOD

(71) Applicant: KYOCERA Corporation, Kyoto-shi, Kyoto (JP)

(72) Inventor: Yutaka IKEDA, Kyoto-shi, Kyoto (JP)

(21) Appl. No.: 18/282,373

(22) PCT Filed: Mar. 16, 2022
(86) PCT No.: PCT/JP2022/011782

§ 371 Date: Sep. 15, 2023

(30) Foreign Application Priority Data
Mar. 19, 2021 (JP) 2021-046199

(51) Int. Cl. B01L 3/00

(52) U.S. Cl. CPC B01L 3/502; B01L 2200/16; B01L 2300/0663

(57) ABSTRACT

To improve the reliability of a measurement result. The measurement system includes a channel, a sensor located in the channel and configured to detect a measurement target in a fluid, an extraction unit configured to extract a feature from an output signal output from the sensor, a storage configured to store a specific model defined on a basis of a specific output from the sensor, and a determiner configured to make a predetermined determination when one or more features deviate from the specific model.

### TECHNICAL FIELD

The present disclosure relates to a measurement system, an analysis program, and a measurement method.

### BACKGROUND OF INVENTION

Conventionally, measurement of a target substance is performed by supplying a fluid such as a specimen to a sensor and observing a signal waveform. For example, Patent Document 1 describes an antibody-antigen mixing detection method using a surface acoustic wave (SAW) sensor.

### CITATION LIST

### Patent Literature

Patent Document 1: JP 2020-159901 A

### SUMMARY

A measurement system according to an aspect of the present disclosure includes a channel, a sensor located in the channel and configured to detect a measurement target in a fluid, an extraction unit configured to extract a feature from an output signal output from the sensor, a storage configured to store a specific model defined on the basis of a specific output from the sensor, and a determiner configured to make a predetermined determination when one or more features deviate from the specific model.

A measurement method according to an aspect of the present disclosure is a measurement method for measuring a measurement target contained in a fluid by analyzing an output signal output from a sensor configured to detect the measurement target in the fluid, the method including supplying a first liquid to the sensor, supplying a gas to the sensor after supplying the liquid, and supplying a second liquid to the sensor after supplying the gas.

A measuring device according to each aspect of the present disclosure may be implemented by a computer. In this case, a control program of the measuring device that causes the computer to operate as each unit (software component) included in the measuring device to implement the measuring device by the computer and a computer-readable recording medium in which the control program is recorded also fall within the scope of the present disclosure.

### BRIEF DESCRIPTION OF THE DRAWINGS

FIG. 1 is a block diagram illustrating a schematic configuration of a measurement system according to a first embodiment of the present disclosure.

FIG. 2 is a diagram illustrating an example of a data structure of a specific model stored in a storage of a measuring device.

FIG. 3 is a flowchart illustrating an example of an analysis method executed in the measurement system.

FIG. 4 is a flowchart illustrating another example of the analysis method executed in the measurement system.

FIG. 5 is a diagram illustrating an appearance of a measurement system according to a second embodiment of the present disclosure.

FIG. 6 is a schematic diagram schematically illustrating an internal configuration of a cartridge.

FIG. 7 is a schematic diagram schematically illustrating an internal configuration of a sensor unit.

FIG. 8 is a block diagram illustrating a configuration of a main part of the cartridge and the measuring device.

FIG. 9 is a flowchart illustrating a flow of processing of a measurement method executed by a measuring device according to the second embodiment of the present disclosure.

FIG. 10 is a graph illustrating an example of a normal model stored in the storage.

FIG. 11 is a diagram illustrating a specific example of a feature and a specific example of a prescribed amount stored in the storage.

FIG. 12 is a diagram illustrating the specific example of the feature and the specific example of the prescribed amount stored in the storage.

FIG. 13 is a diagram illustrating the specific example of the feature and the specific example of the prescribed amount stored in the storage.

FIG. 14 is a diagram illustrating the specific example of the feature and the specific example of the prescribed amount stored in the storage.

FIG. 15 is a diagram illustrating the specific example of the feature and the specific example of the prescribed amount stored in the storage.

FIG. 16 is a diagram illustrating the specific example of the feature and the specific example of the prescribed amount stored in the storage.

FIG. 17 is a diagram illustrating the specific example of the feature and the specific example of the prescribed amount stored in the storage.

### DESCRIPTION OF EMBODIMENTS

### First Embodiment

An embodiment of the present disclosure will be described in detail below. In the present disclosure, a failure to obtain a correct measurement result due to a malfunction occurring in a measuring device or a measurement target is referred to as “measurement failure”. The present inventors have found that an output signal output from a sensor when measurement failure occurs indicates a feature different from a feature of an output signal when each step of measurement is normally executed. In the following embodiments, an analysis device that determines the presence or absence of measurement failure by analyzing the output signal obtained for measurement in a measurement system and an analysis method executed by the analysis device will be described.

Measurement System

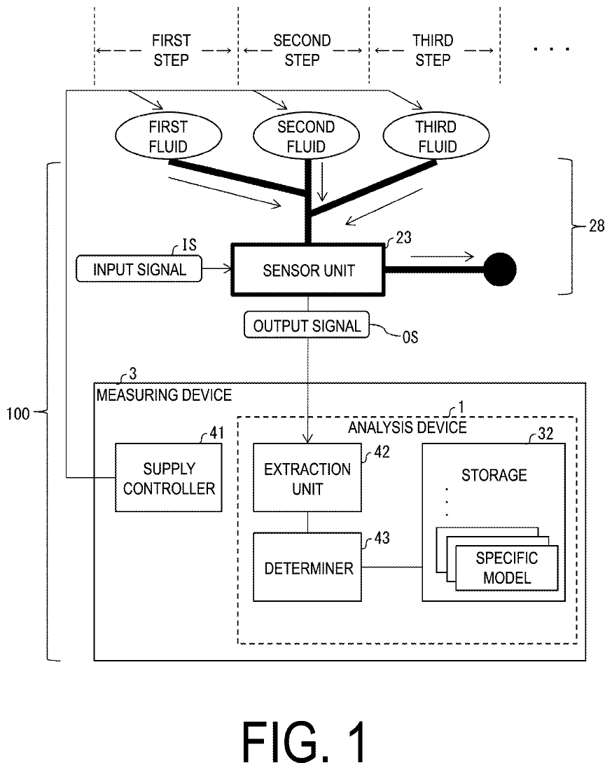

FIG. 1 is a block diagram illustrating a schematic configuration of a measurement system 100. The measurement system 100 of the present embodiment is, for example, a system for measuring a measurement target by calculating a concentration of the measurement target contained in a specimen. As an example, an analysis device 1 according to the present disclosure may be applied to a measuring device 3 that calculates the concentration of the measurement target among elements constituting the measurement system 100.

The measurement system 100 includes a channel 28, a sensor such as a sensor unit 23 located in the channel 28 and configured to detect a measurement target in a fluid, an extraction unit 42 configured to extract a feature from an output signal OS output from the sensor, a storage 32 configured to store a specific model defined on the basis of a specific output from the sensor, and a determiner 43 configured to make a predetermined determination when one or more features deviate from the specific model. According to the configuration described above, a predetermined determination can be made with respect to an event deviating from the specific model which has occurred in one or more steps for measuring the measurement target in the fluid present in the channel 28.

The specific model stored in the storage 32 may be specified by a prescribed amount defined on the basis of the output signal OS when the output of the sensor is in a specific state. As a result, the determiner 43 can make a predetermined determination on an event deviating from the specific model by comparing a predefined prescribed amount with an amount indicated by the measured value of the output signal OS obtained from the sensor.

The extraction unit 42 may extract, as a feature, a change amount in the output signal OS from an input signal IS input to the sensor. The extraction unit 42 can extract, as a feature, the change amount obtained by comparing the input signal IS and the output signal OS. Accordingly, the determiner 43 can make a predetermined determination regarding an event in which the change amount deviates from the specific model.

The measurement system 100 may further include a supply controller 41 that supplies one or more kinds of fluids to the sensor. The supply controller 41 may be provided in the measuring device 3. In the illustrated example, the one or more kinds of fluids are a first fluid, a second fluid, and a third fluid. However, the number of kinds of fluids may be smaller or larger than this.

The prescribed amount for specifying the specific model may be, for example, one or more threshold values for specifying a specific range of the feature as the specific model.

For example, the determiner 43 makes a predetermined determination when the change amount in a first step in which the first fluid is supplied to the sensor deviates from the specific range specified by the threshold value described above for the first step. For a second step in which the second fluid is supplied to the sensor, the determiner 43 can compare the change amount in the second step with the threshold value of the second step. The determiner 43 may perform the same comparison in a third step in which the third fluid is supplied.

Accordingly, the determiner 43 can make a predetermined determination by determining whether or not the change amount deviates from the specific range for each step in which the type of fluid is different. For example, the determiner 43 can make a predetermined determination as to whether or not the supply controller 41 has supplied the first fluid to the sensor in the first step.

The specific model stored in the storage 32 may be a normal model specified by the prescribed amount defined on the basis of the output signal OS when the output of the sensor is normal. The determiner 43 may determine that measurement failure has occurred when one or more features deviate from the normal model.

According to the configuration described above, the occurrence of an event deviating from the normal model in each step performed by the measurement system 100 for measuring the measurement target in the fluid present in the channel 28 can be detected, and measurement failure can be determined on the basis of the detected event. When measurement failure is determined not to occur, the user can take some measures such as not adopting the measurement result obtained from the measurement determined to be the measurement failure, performing re-measurement, or ensuring that the reliability of the measurement is not impaired.

Data Structure

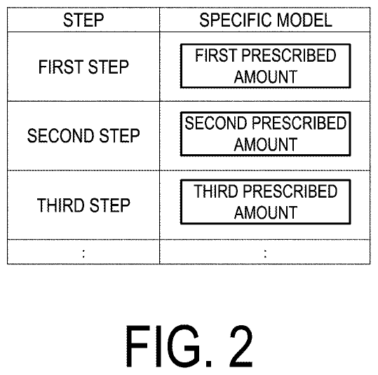

FIG. 2 is a diagram illustrating an example of a data structure of a specific model stored in the storage 32. In the case of a plurality of measurement steps, one specific model may be defined, but a specific model may be defined for each of the plurality of steps. As described above, the specific model may be specified by a prescribed amount defined on the basis of the output signal OS when the output of the sensor is in a specific state. The prescribed amount may be one or more threshold values indicating a specific range.

For example, in the example illustrated in FIG. 2, the specific model is defined by a prescribed amount for each of a plurality of steps constituting the measurement. As a specific example, a specific model for making a predetermined determination regarding the first step of the measurement may be stored in the storage 32 as a first prescribed amount. A specific model for making a predetermined determination regarding the second step may be stored in the storage 32 as a second prescribed amount. Similarly, a third prescribed amount may be stored in the storage 32 as a specific model in association with the third step.

As described above, the specific model may be a normal model indicating a normal range specified by one or more threshold values.

For example, the illustrated first prescribed amount may be one or more threshold values indicating the normal range for the first feature extracted from the output signal OS output from the sensor during the execution of the first step.

As a specific example, the determiner 43 may compare the first feature with one or more threshold values defined as the first prescribed amount. The determiner 43 may determine that measurement failure has occurred in the first step on the basis of the fact that the first feature deviates from the normal range indicated by the one or more threshold values described above.

Note that a plurality of prescribed amounts may be defined for one step.

Process Flow

In the measurement performed by the measurement system 100, a plurality of fluids may be supplied to the sensor in a plurality of steps. The extraction unit 42 may extract a feature for each of two or more steps among the plurality of steps.

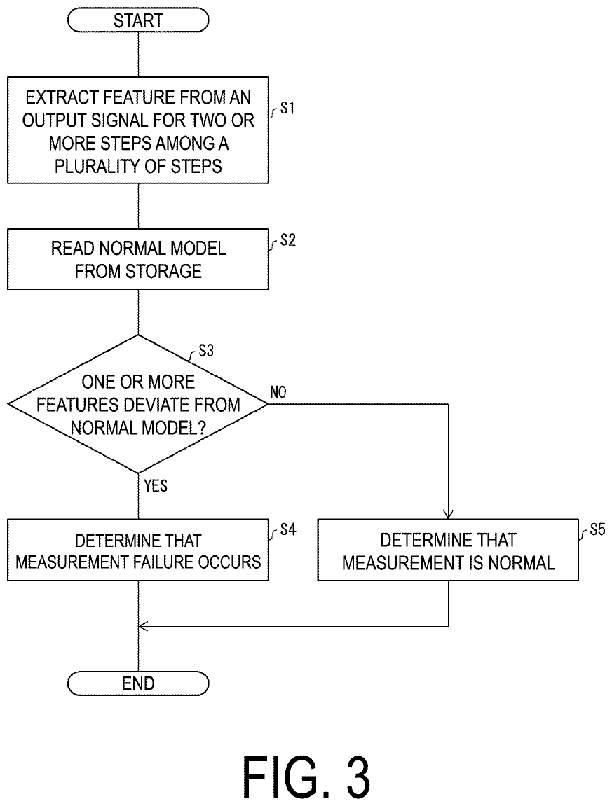

FIG. 3 is a flowchart illustrating an example of an analysis method executed by the analysis device 1 applied to the measurement system 100 or the measuring device 3.

In step S1, the extraction unit 42 extracts features for two or more steps among the plurality of steps from the output signal OS output from the sensor unit 23 for measuring the measurement target in the fluid present in the channel 28. For example, the extraction unit 42 may extract, from the output signal OS, the first feature for the first step and the second feature for the second step among the first step to the third step.

In step S2, the determiner 43 reads a specific model, for example, a normal model, from the storage 32. For example, the determiner 43 may read a first normal model for the first step and a second normal model for the second step from the storage 32.

In step S3, the determiner 43 compares the extracted feature with the normal model, and determines whether or not one or more features deviate from the normal model. As an example, the determiner 43 may compare the first feature with the first normal model and may compare the second feature with the second normal model. When the determiner 43 determines that at least one of the first feature and the second feature deviates from the compared normal model, the determiner 43 advances the process from YES in S3 to S4. When the determiner 43 determines that all of the extracted features, for example, both of the first feature and the second feature are not deviated from the normal model, the determiner 43 advances the process from NO in S3 to S5.

In step S4, the determiner 43 determines that measurement failure has occurred in the measurement in which the output signal OS is obtained.

In step S5, the determiner 43 determines that the measurement is normally performed in the measurement in which the output signal OS is obtained.

According to the configuration and method described above, the presence or absence of measurement failure can be determined in measurement in which a plurality of steps of supplying a fluid to a sensor are executed for each type of fluid.

Process Flow

In another example, the extraction unit 42 may extract the first feature for the first step from the output signal OS obtained when the first step is performed. The determiner 43 may compare the first feature with the normal model of the first step and determine the presence or absence of measurement failure for the first step. When the determiner 43 determines that there is no measurement failure in the first step, the extraction unit 42 may extract the second feature for the second step from the output signal OS obtained when the second step is performed. The determiner 43 may compare the second feature with the normal model of the second step and determine the presence or absence of measurement failure in the second step. When the determiner 43 determines that measurement failure occurs in the second step, the determiner 43 may determine that measurement failure has occurred in the entire measurement including the second step.

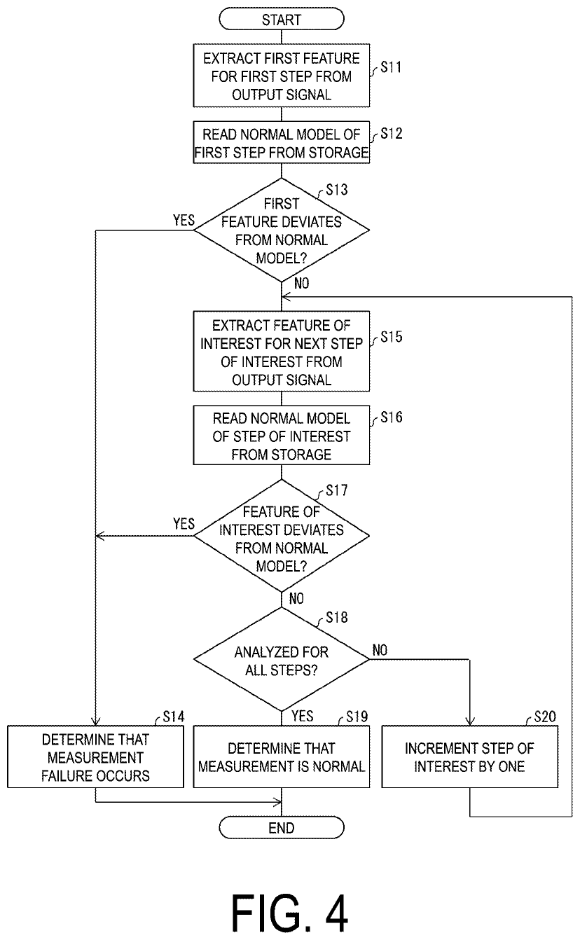

FIG. 4 is a flowchart illustrating an example of an analysis method executed by the analysis device 1 applied to the measurement system 100 or the measuring device 3.

In step S11, the extraction unit 42 extracts the first feature in the first step from the output signal OS.

In step S12, the determiner 43 reads the normal model associated with the first step from the storage 32. The read normal model may be, for example, the first prescribed amount. In step S13, the determiner 43 compares the first feature with the normal model, and determines whether or not the first feature deviates from the normal model. For example, the determiner 43 may determine whether or not the first feature deviates from the normal range indicated by the first prescribed amount. When the determiner 43 determines that the first feature deviates from the normal model, the determiner 43 advances the process from YES in S13 to S14. When the determiner 43 determines that the first feature does not deviate from the normal model, the determiner 43 determines that the step of interest which is a target for comparison between the feature and the prescribed amount is normally performed, and the determiner 43 advances the process from NO in S13 to S15. When the process proceeds from NO in S13 to S15, the determiner 43 can determine that the first step has been normally performed. Then, the extraction unit 42 can continue the analysis with the next step as the step of interest.

In step S14, the determiner 43 determines that measurement failure has occurred in the measurement in which the output signal OS has been obtained.

In step S15, the extraction unit 42 sets a step subsequent to the previously processed step as a step of interest, and extracts a feature of interest of the step of interest from the output signal OS. When the process proceeds from NO in S13 to S15, the extraction unit 42 sets the second step subsequent to the first step as the step of interest, and extracts the second feature of the second step from the output signal OS.

In step S16, the determiner 43 reads the normal model of the step of interest from the storage 32. For example, the determiner 43 may read the second prescribed amount of the second step from the storage 32.

In step S17, the determiner 43 compares the feature of interest with the normal model of the step of interest, and determines whether or not the feature of interest deviates from the normal model. When the determiner 43 determines that the feature of interest deviates from the normal model, the determiner 43 advances the process from YES in S17 to S14. When the determiner 43 determines that the feature of interest does not deviate from the normal model, the determiner 43 determines that the step of interest is normally performed, and the determiner 43 advances the process from NO in S17 to S18.

In step S18, for all the steps constituting the measurement, the determiner 43 performs the analysis of the output signal OS, that is, determines whether or not the determination of the presence or absence of measurement failure has been performed. When the analysis has been completed for all the steps, the determiner 43 advances the process from YES in S18 to S19. When a step for which analysis has not been completed remains, the determiner 43 advances the process from NO in S18 to S20.

In step S19, the determiner 43 determines that the measurement is normal measurement on the basis of the fact that measurement failure has not occurred in all the steps constituting the measurement.

In step S20, the determiner 43 moves the step of interest to the next step. For example, when the presence or absence of measurement failure has been determined for the second step in S17 which is the previous step, the determiner 43 increments the number of the step of interest or the like by one, sets the next third step as the step of interest, and repeats the processes after S15.

According to the configuration and method described above, the presence or absence of measurement failure can be determined in measurement in which a plurality of steps of supplying a fluid to a sensor are executed for each type of fluid. For example, the presence or absence of measurement failure can be determined for each step. Even if the first step proceeds normally, it can be determined that measurement failure has occurred in the entire measurement including the first step and the second step in a case where measurement failure occurs in the second step.

### Second Embodiment

Another embodiment of the present disclosure will be described below. Note that, for convenience of description, a member having the same function as that of a member described in the embodiments described above is denoted by the same reference sign, and description thereof will not be repeated.

Appearance of Measurement System 100

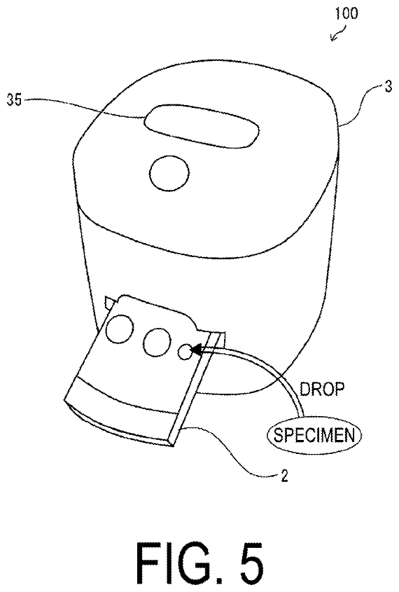

FIG. 5 is a diagram illustrating an appearance of the measurement system 100 according to the embodiment. The measurement system 100 includes, for example, the measuring device 3 and a cartridge 2 (channel device). FIG. 5 illustrates a state in which the cartridge 2 is not completely mounted on the measuring device 3 but is being inserted. In the present embodiment, the analysis device 1 described in the first embodiment is incorporated in the measuring device 3.

In the present embodiment, as an example, in the measurement system 100, the measuring device 3 and the cartridge 2 are configured as separate bodies, and measurement is executed by inserting the cartridge 2 into the measuring device 3 and electrically connecting the cartridge 2 to the measuring device 3. In such a measurement system 100, as will be described below, fluids such as a reagent and a specimen liquid used for measurement may be accommodated in the cartridge 2 in advance. When the measuring device 3 and the cartridge 2 are configured as separate bodies, the cartridge 2 is a consumable item, and as an example, one cartridge 2 is used to perform measurement on one individual subject. In another example, a plurality of cartridges 2 may be used for one individual subject depending on the type of measurement.

Such a configuration of the measurement system 100 may be adopted, for example, in a case of executing rapid testing called point of care testing (POCT) in which measurement is executed immediately after specimen acquisition and a result is presented to a user. In this case, the measuring device 3 may be configured as a relatively small device that may be located, for example, in pharmacies, clinics, homes, etc.

Without being limited to the above-described example, the measurement system 100 of the present disclosure can also be applied to a case where a large amount of specimens temporarily collected in an inspection room or the like are simultaneously measured by the large measuring device 3. In this case, a configuration can be adopted in which the fluids such as a reagent and a specimen liquid are fed into the cartridge from the measuring device 3 and then fed into the cartridge when the measurement is executed.

The measurement system 100 according to an embodiment is a system that measures a measurement target contained in a specimen P such as urine, blood, or saliva and presents a measurement result to a user. The user may be an operator of the measuring device 3 in charge of the measurement work, may be a client such as a doctor who requests the measurement, or may be a subject such as a patient who provides the specimen P.

The measurement system 100 includes, for example, the cartridge 2 and the measuring device 3. After the cartridge 2 is inserted into the measuring device 3 and the cartridge 2 and the measuring device 3 are electrically connected to each other, the measuring device 3 may immediately start the measurement of the cartridge 2 or may start the measurement in accordance with an input operation of the user. In another example, the measuring device 3 may perform authentication of the cartridge 2 and start measurement when the authentication is successful. The measuring device 3 may include a display 35 and present various kinds of information to the user. For example, the measuring device 3 can cause the display 35 to display the progress of measurement, a message prompting the user to perform some input operation, an error message when measurement failure occurs, and the like.

In the measurement system 100, for example, the specimen P may be urine. In the following description, the measurement system 100 is assumed to be a system for measuring the concentration of a measurement target contained in urine as the specimen P. However, the specimen P is not limited to urine, and may be any substance derived from a living body. The specimen P may be, for example, blood, sweat, saliva, nasal discharge, or the like. The cartridge 2 is appropriately configured so that the measuring device 3 can detect the specimen P accommodated in the cartridge 2. An example of the configuration of the cartridge 2 will be described below in detail with reference to other figures.

In another example, the measurement system 100 according to the present disclosure may be a system for measuring tumor markers for various cancers, viruses such as influenza, microbes, or substances for testing specific diseases (for example, hemoglobin A1c for diabetics). That is, the measurement system 100 may be used for quantitative analysis such as measurement of the concentration of a measurement target contained in the specimen P, or may be used for qualitative analysis for specifying the type of a substance or the like contained in the specimen P, for example.

As another example, the measurement system 100 may be used to diagnose a physiological tendency, a disease, or the like of the subject on the basis of the measurement result, or to support a doctor's diagnosis. The measurement result output from the measurement system 100 may include, for example, the presence or absence of a measurement target such as a virus or the concentration of a measurement target such as cholesterol, or may include a physiological tendency of the subject or a diagnosis result of a disease on the basis of the presence or absence or the concentration. The physiological tendency may be information indicating a tendency related to the constitution of the subject. For example, information indicating whether the subject is prone to producing a certain substance, whether the subject is susceptible to a particular disease, and whether the subject has had a certain disease, corresponds to information indicating a physiological tendency.

Configuration of Cartridge 2

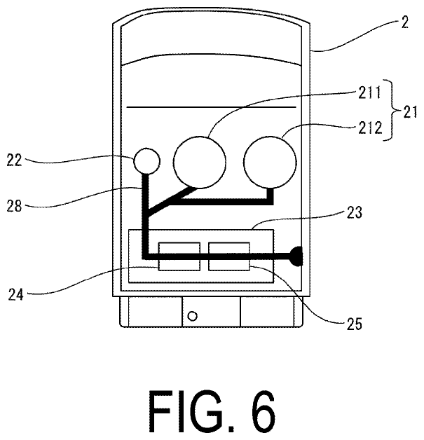

FIG. 6 is a schematic diagram schematically illustrating an internal configuration of the cartridge 2. The cartridge 2 may be a disposable cartridge attachable to and detachable from the measuring device 3. The cartridge 2 may be made of, for example, a resin. The resin may be, for example, polycarbonate, cycloolefin polymer, polymethyl methacrylate resin, polydimethylsiloxane, or the like. The cartridge 2 according to an embodiment is formed of polymethyl methacrylate resin.

The cartridge 2 according to an embodiment includes a holding section 21 (first container, second container), a liquid receiving section 22 (first container, second container), a sensor unit 23, and a channel 28.

The holding section 21 holds a liquid, in particular, a liquid such as a reagent that does not contain a measurement target. In the present embodiment, as an example, the measurement system 100 may use two different types of reagents for measurement. Hereinafter, the holding section 21 that holds a first reagent is referred to as a first holding section 211 (first container, second container), and the holding section 21 that holds a second reagent is referred to as a second holding section 212 (first container, second container). In another example, the measurement system 100 may use one type of reagent for measurement, or may use three or more types of reagents for measurement. That is, the cartridge 2 may include one holding section 21 or three or more holding sections 21.

As an example, various liquids are sealed in the holding section 21. The holding section 21 may be formed of any material according to the type of liquid used in the test. For example, when a liquid that is easily oxidized is sealed, the holding section 21 may be formed of a material having a low oxygen permeability. For example, when an acidic liquid is used, the holding section 21 may be formed of an acid-resistant material. More specifically, the holding section 21 may be formed of, for example, aluminum, polypropylene, polyethylene, or the like. In the embodiment, the holding section 21 is made of polypropylene. Note that the holding section 21 may be formed by a conventionally known method such as casting.

The holding section 21 is not limited to a specific shape as long as the holding section 21 can hold the liquid. The holding section 21 may have any shape, for example, a truncated pyramid, such as a truncated cone, a truncated triangular pyramid, or a truncated quadrangular pyramid, a pyramid, such as a cone, a triangular pyramid, or a quadrangular pyramid, or a prism, such as a cylinder, a triangular prism, or a quadrangular prism, or a combination thereof. In the embodiment, the holding section 21 is a truncated cone. As an example, when a pressing pin (not illustrated) provided in the measuring device 3 is pressed down toward the holding section 21, the holding section 21 is unsealed. Accordingly, the liquid accommodated in the holding section 21 is pushed out to the channel 28 connected to the holding section 21, passes through the channel 28, and is supplied to the sensor unit 23.

The liquid receiving section 22 takes in and holds, inside the cartridge 2, a liquid, in particular, the specimen P as a specimen liquid containing a measurement target. The shape of the liquid receiving section 22 is not limited. The liquid receiving section 22 is connected to the channel 28. The specimen P accommodated in the liquid receiving section 22 is pushed out from the liquid receiving section 22 by being pressed by a pressing pin (not illustrated) of the measuring device 3, and is supplied to the sensor unit 23 via the channel 28 that has been connected. The liquid receiving section 22 may be formed integrally with the channel 28, or may be formed separately from the channel 28. The liquid receiving section 22 may be formed by a conventionally known technique.

The sensor unit 23 detects a measurement target contained in the specimen P. The sensor unit 23 includes at least one sensor that detects a measurement target. The sensor unit 23 may include a plurality of sensors. As an example, the sensor unit 23 may include two sensors of a detector 24 (sensor, first sensor) and a reference section 25 (sensor, second sensor). In the following, when the sensor unit 23 includes a single sensor, the sensor unit 23 may be simply referred to as a sensor. When the sensor unit 23 includes a plurality of sensors, for example, the detector 24 and the reference section 25, the detector 24 and the reference section 25 may be collectively referred to as a sensor in a case where it is not necessary to distinguish between individual sensors. The entire sensor unit 23 including the detector 24 and the reference section 25 may be referred to as a sensor.

The channel 28 is a channel for supplying one or more kinds of fluids to the sensor unit 23. The channel 28 is formed inside the cartridge 2 so that the above-described components of the cartridge 2, specifically, the first holding section 211, the second holding section 212, and the liquid receiving section 22, are connected to the sensor unit 23. The fluid accommodated in the first holding section 211, the second holding section 212, and the liquid receiving section 22 is supplied to the sensor unit 23 via the channel 28.

The channel 28 may be formed in the cartridge 2 in any shape, including known shapes. As an example, the channel 28 may be formed so that each liquid accommodated in each of the first holding section 211, the second holding section 212, and the liquid receiving section 22 reaches the sensor unit 23 through the channel 28. Thus, before the specimen P passes through the channel 28, the first reagent is caused to pass through the channel 28, whereby the environment through which the specimen P passes may be grasped and calibration may be performed. After the specimen P passes through the channel 28, the channel 28 or the sensor unit 23 may be cleaned by passing the second reagent therethrough.

In the present embodiment, as an example, the cartridge 2 and the measuring device 3 are configured such that a plurality of types of fluids are sequentially supplied to the sensor unit 23 without being mixed, as will be described below. However, in another example of the measurement system 100 in the present disclosure, the cartridge 2 and the measuring device 3 may be configured such that a plurality of types of fluids are mixed in the channel 28 and supplied to the sensor unit 23.

As described above, the cartridge 2 can be electrically connected to the measuring device 3, and can mutually input and output an electric signal to and from the measuring device 3. Terminals or the like for electrically connecting the cartridge 2 and the measuring device 3 may be produced by a conventionally known method. In other examples, the cartridge 2 need not be physically attached to the measuring device 3. For example, the cartridge 2 may include a communicator configured to communicate with the measuring device 3. In this case, the cartridge 2 may transmit and receive various kinds of information such as an electric signal relating to the test to and from the measuring device 3 by wired or wireless communication.

Configuration of Sensor Unit 23

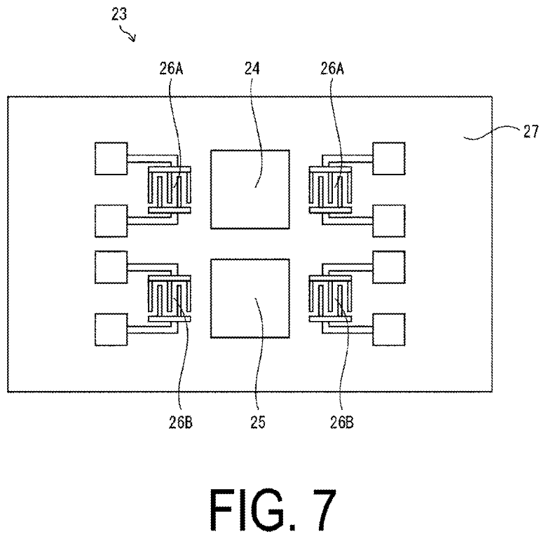

FIG. 7 is a schematic diagram schematically illustrating an internal configuration of the sensor unit 23. The sensor unit 23 according to the embodiment is, for example, a sensor using an elastic wave, and includes the detector 24, the reference section 25, a pair of interdigital transducer (first IDT) electrodes 26A, a pair of second IDT electrodes 26B, and a substrate 27. The detector 24, the reference section 25, the pair of first IDT electrodes 26A, and the pair of second IDT electrodes 26B may be located on the substrate 27.

The detector 24 and the reference section 25 of the sensor unit 23 may be sensors using, for example, an elastic wave, a quartz crystal microbalance (QCM), a surface plasmon resonance (SPR), a field effect transistor (FET), or the like. That is, the sensor unit 23 may mutually convert the electric signal and the elastic wave, the QCM, the SPR, the FET, or the like. The sensor unit 23 may be manufactured by a conventionally known method. As described above, the sensor unit 23 according to the embodiment is, for example, a sensor device using an elastic wave, and can convert an electric signal into an elastic wave and an elastic wave into an electric signal. In this case, the measuring device 3 may hold information unique to the sensor that uses the elastic wave, such as the initial phases of the elastic wave and the orientation of the substrate 27.

A substance (reactant) that reacts with the measurement target may be fixed to the detector 24. Therefore, the measurement target contained in the specimen P can react with the reactant in the detector 24. The detector 24 may be made of, for example, metal. Specifically, the detector 24 may be made of, for example, a metal such as gold, chromium, or titanium, or a combination of these metals. The detector 24 may be a single-layer metal film made of a single material or a multi-layer metal film made of a plurality of materials. The material constituting the detector 24 is not limited to the above-described metals, and any material having a function of fixing the reactant can be adopted. The detector 24 may be produced by a conventionally known method.

The reactant may be, for example, an antibody, an enzyme, or the like. That is, the measurement target may be, for example, an antigen, a substrate, or the like. The measurement target is not limited to these examples. For example, the measurement target may be an antibody, an enzyme, or the like. In this case, the reactant may be, for example, an antigen and a substrate. As described above, the measurement target to be measured by the measuring device 3 may be selected as appropriate according to the symptom or disease to be diagnosed, and the reactant paired with the measurement target may be selected as appropriate.

The pair of first IDT electrodes 26A can generate an elastic wave between the pair of first IDT electrodes 26A. Of the generated elastic wave, an elastic wave propagating on the surface of the substrate 27 is also referred to as a surface acoustic wave (SAW). The pair of first IDT electrodes 26A may be disposed on the substrate 27 so that the detector 24 is sandwiched therebetween. In the sensor unit 23 according to the embodiment, an electric signal (input signal) is input to one of the pair of first IDT electrodes 26A by control of the measuring device 3. The input electric signal is converted into an elastic wave propagating toward the detector 24 and is transmitted from one of the first IDT electrodes 26A. The transmitted elastic wave passes through the detector 24. The other of the first IDT electrodes 26A can receive the elastic wave passed through the detector 24. The received elastic wave is converted into an electric signal (output signal). The converted electric signal is output to the measuring device 3. The pair of first IDT electrodes 26A may be formed of, for example, metals such as gold, chromium, and titanium, or a combination of these metals. The pair of first IDT electrodes 26A may be single-layer electrodes made of a single material or multi-layer electrodes made of a plurality of materials.

In the detector 24, the measurement target and the reactant react with each other, thereby changing the propagation characteristics of the elastic wave propagating on the substrate 27. Specifically, the measurement target reacts with the reactant, thereby the weight applied to the substrate 27 or the viscosity of the liquid in contact with the surface of the substrate 27 changes. The magnitude of these changes correlates with the amount of reaction between the measurement target and the reactant. The characteristic of the elastic wave (e.g., phase, amplitude, or period) changes with the propagation of the elastic wave through the detector 24. The magnitude of the change in the characteristic correlates with the magnitude of the weight applied to the substrate 27 or the magnitude of the viscosity of the liquid in contact with the surface of the substrate 27. Therefore, the measuring device 3 can measure the measurement target on the basis of the change in the propagation characteristic of the elastic wave by analyzing the output signal output from the sensor unit 23. Specifically, the measuring device 3 can calculate the concentration of the measurement target contained in the specimen P.

The sensor unit 23 may include two or more combinations of the detector 24 and the pair of IDT electrodes 26A. In this case, the measuring device 3 may measure different types of target substances for each combination, for example. Alternatively, for example, the measuring device 3 may measure the same type of target substances in a plurality of combinations and compare the respective measurement results.

Unlike the detector 24, the reactant is not fixed to the reference section 25. Therefore, in the reference section 25, a reaction between the measurement target and the reactant does not occur. Thus, the reference section 25 can function as a control of the detector 24. The reference section 25 may be configured to be the same as or similar to the detector 24.

The pair of second IDT electrodes 26B can generate an elastic wave between the pair of second IDT electrodes 26B. The pair of second IDT electrodes 26B may be disposed on the substrate 27 so that the reference section 25 is sandwiched. In the sensor unit 23 according to the embodiment, an electric signal (input signal) is input to one of the pair of second IDT electrodes 26B by the control of the measuring device 3. The input electric signal is converted into an elastic wave propagating toward the reference section 25 and is transmitted from one of the second IDT electrodes 26B. The transmitted elastic wave passes through the reference section 25. The other of the second IDT electrodes 26B can receive the elastic wave passed through the reference section 25. The received elastic wave is converted into an electric signal (output signal). The converted electric signal is output to the measuring device 3. The pair of second IDT electrodes 26B may be configured to be the same as or similar to the pair of first IDT electrodes 26A.

The substrate 27 may be, for example, a substrate having piezoelectricity. As an example, the substrate 27 may be a quartz substrate. The substrate 27 is not limited to a quartz crystal substrate, and may be made of any material that can propagate an elastic wave. The substrate 27 may be produced by a conventionally known method.

Configuration of Measurement System 100

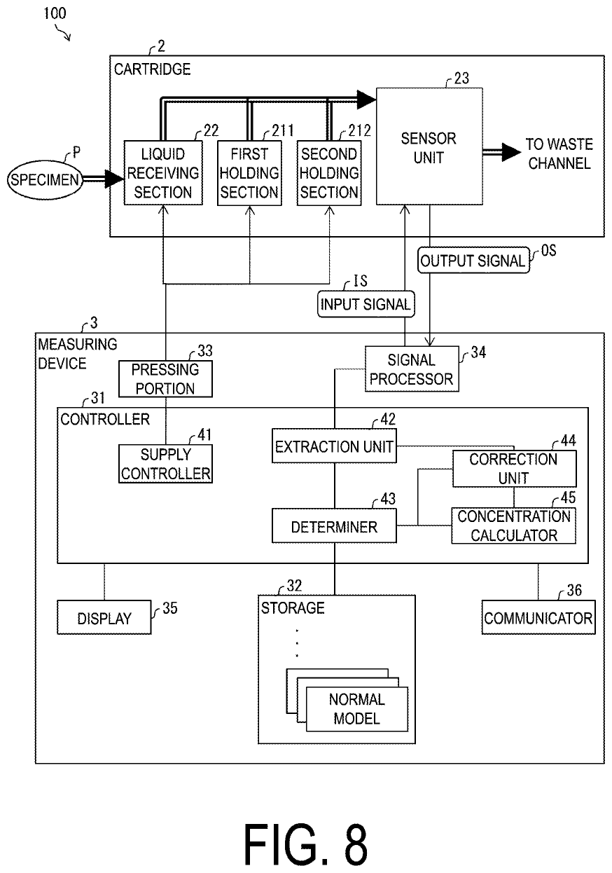

FIG. 8 is a block diagram illustrating a configuration of a main part of the cartridge 2 and the measuring device 3 constituting the measurement system 100. As described above, the measurement system 100 includes the cartridge 2 and the measuring device 3.

As described above, the pressing pin (not illustrated) of the connected measuring device 3 is pressed down toward the cartridge 2, toward each of the liquid receiving section 22, the first holding section 211, and the second holding section 212 of the cartridge 2. Accordingly, the liquid accommodated in each of the liquid receiving section 22, the first holding section 211, and the second holding section 212 is pushed out to the channel 28, and is supplied to the sensor unit 23 via the channel 28.

Hardware Configuration of Measuring Device 3

The measuring device 3 includes, for example, a controller 31, the storage 32, a pressing portion 33, a signal processor 34, the display 35, and a communicator 36.

The controller 31 integrally controls each unit of the measuring device 3. The controller 31 includes, for example, an arithmetic device such as a central processing unit (CPU) or a dedicated processor. Each portion of the controller 31 which will be described below can be implemented by the above-described arithmetic device reading a program stored in a storage device (for example, the storage 32) implemented by a read only memory (ROM) or the like into a random access memory (RAM) or the like and executing the program.

The storage 32 stores various kinds of data to be processed by the controller 31 and various kinds of data to be referred to in the processing. In the present embodiment, as an example, the storage 32 stores a normal model. The normal model is referenced by the controller 31 when the controller 31 determines the presence or absence of measurement failure.

The pressing portion 33 is a driving mechanism for pushing out the liquid from each of the liquid receiving section 22, the first holding section 211, and the second holding section 212. The pressing portion 33 includes, for example, a pressing pin (not illustrated) and an actuator that generates power for pressing down the pressing pin toward the cartridge 2. In the present embodiment, as an example, the liquids accommodated in each of the liquid receiving section 22, the first holding section 211, and the second holding section 212 are sequentially fed in a predetermined order at predetermined intervals so as not to be mixed in the channel 28. Therefore, the pressing portion 33 may have an appropriate configuration so that the pressing pins for pressing down each of the liquid receiving section 22, the first holding section 211, and the second holding section 212 are pressed down in a predetermined order and at predetermined intervals. Alternatively, software, specifically, a supply controller 41 to be described below, may control the order and interval of pressing of each pressing pin in the pressing portion 33.

The signal processor 34 transmits and receives an electric signal to and from the sensor unit 23 electrically connected the signal processor 34. When the electric signal to be analyzed for measurement is the output signal OS output from the sensor unit 23, the signal processor 34 receives at least the output signal OS from the sensor unit 23. When the analysis is performed using both the input signal IS input to the sensor unit 23 and the output signal OS described above, the signal processor 34 further generates the input signal IS under the control of the controller 31 and transmits the input signal IS to the sensor unit 23.

The display 35 outputs various data processed by the controller 31 as visual information that can be visually recognized by the user.

The communicator 36 is configured by wireless or wired communication means, and communicates with other devices. In the measurement system 100 in which the measuring device 3 does not need to communicate with an external device, the communicator 36 may be omitted.

The measuring device 3 may further include an operator that receives an input operation of the user. The operator may be configured as a hardware component such as a button or a switch, or may be configured by a combination of a touch panel formed integrally with the display 35 and a software component displayed on the display 35.

Software Configuration of Measuring Device 3

The controller 31 includes, for example, the extraction unit 42 and the determiner 43. The controller 31 may include the supply controller 41 and a concentration calculator 45 (calculator) as necessary. In the present embodiment, the correction unit 44 may be omitted in the controller 31.

The extraction unit 42, the determiner 43, and the storage 32 in which the normal model is stored may constitute the analysis device 1 according to the first embodiment. That is, the analysis device 1 according to the first embodiment may be implemented by being incorporated in the measuring device 3 according to the present embodiment. In another example, the analysis device 1 may further include the correction unit 44 and the concentration calculator 45.

The supply controller 41 supplies one or more kinds of fluids to the sensor unit 23. The supply controller 41 may be, for example, a pressing controller that controls the pressing portion 33 to supply each fluid accommodated in the cartridge 2 to the sensor unit 23. As an example, the supply controller 41 as the pressing controller controls the actuator to press down the pressing pin so that the liquid accommodated in each of the liquid receiving section 22, the first holding section 211, and the second holding section 212 is fed in a predetermined order and at a predetermined interval. In the present embodiment, as an example, the supply controller 41 may control the pressing portion 33 to sequentially press down the pressing pin of the first holding section 211, the pressing pin of the liquid receiving section 22, and the pressing pin of the second holding section 212. Thus, the first reagent accommodated in the first holding section 211, the specimen liquid containing the specimen P accommodated in the liquid receiving section 22, and the second reagent accommodated in the second holding section 212 are sequentially supplied to the sensor unit 23 through the channel 28.

The supply controller 41 may control the pressing portion 33 such that the step of supplying a gas to the sensor unit 23 is performed between the step of supplying the previous liquid to the sensor unit 23 and the step of supplying the next liquid to the sensor unit 23. For example, the supply controller 41 may perform control such that after the previous liquid is discharged from the sensor unit 23, the next liquid is pushed out at an interval so that at least a part of the channel 28 and the sensor unit 23 through which the next liquid passes is filled with a gas.

Accordingly, in the channel 28 and the sensor unit 23, the gas is interposed between the previous liquid and the next liquid, and thus the two liquids are sequentially supplied to the sensor unit 23 without being mixed.

The concentration calculator 45 analyzes the output signal OS output from the sensor unit 23 in the plurality of steps for supplying the fluid to the sensor unit 23 executed by the supply controller 41. Then, the concentration calculator 45 calculates the concentration of the measurement target contained in at least one of the fluids on the basis of the analysis result.

The measuring device 3 may further include the extraction unit 42 and the determiner 43 described in the first embodiment, in addition to the concentration calculator 45.

According to the configuration described above, the measuring device 3 can not only analyze the output signal OS obtained by performing the measurement and calculate the concentration as the measurement result, but also analyze the same output signal OS and make a predetermined determination regarding an event deviating from the specific model which has occurred in one or more steps for measuring the measurement target in the fluid present in the channel 28. That is, the measuring device 3 does not need to perform a separate process with the sensor unit 23 to obtain an output signal in order to perform a predetermined determination such as the presence or absence of measurement failure in the outputting step, and can make a predetermined determination at the same time as when the calculation of the concentration which is the main purpose of the measurement is executed.

The correction unit 44 may correct the output signal OS or the feature extracted from the output signal OS as necessary. The output signal OS or the feature corrected by the correction unit 44 is used by the concentration calculator 45 to calculate the concentration of the measurement target.

Measurement Method

The measurement method of the present disclosure is a measurement method for measuring the measurement target contained in a fluid by analyzing the output signal OS output from a sensor such as the sensor unit 23 configured to detect the measurement target in the fluid. The measurement method generally includes a first step of supplying a first liquid to the sensor, a second step of supplying a gas to the sensor after the first step, and a third step of supplying a second liquid to the sensor after the second step.

The above-described measurement method may be executed by, for example, the measuring device 3 included in the measurement system 100. The measurement system 100 of the present disclosure includes the measuring device 3. The measuring device 3 includes the supply controller 41 that supplies one or more kinds of fluids to a sensor such as the sensor unit 23. The supply controller 41 executes the first step of supplying the first liquid to the sensor, the second step of supplying a gas to the sensor after the first step, and the third step of supplying the second liquid to the sensor after the second step.

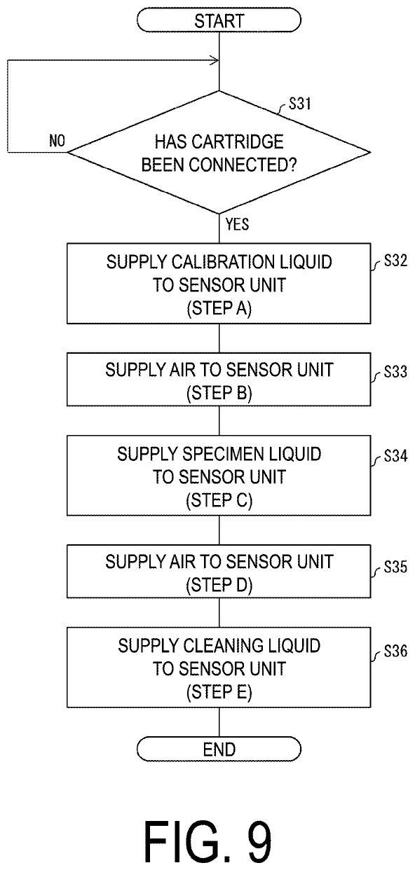

FIG. 9 is a flowchart illustrating a flow of processing of a measurement method executed by the measuring device 3 according to an embodiment of the present disclosure. In the example illustrated in FIG. 9, the measurement system 100 performs measurement including five steps from a step A to a step E as an example.

In step S31, the controller 31 of the measuring device 3 detects that the cartridge 2 is electrically connected to the measuring device 3. In the measurement system 100 in which the cartridge 2 is not provided, this step may be omitted. Upon detecting that the cartridge 2 has been connected, the controller 31 advances the process from YES in S31 to S32.

In step S32, the supply controller 41 executes the first step of supplying the first liquid to the sensor. For example, the supply controller 41 may execute, as the first step, the step A of supplying the calibration liquid as the first liquid accommodated in the first holding section 211 of the cartridge 2 to the sensor unit 23. The step A is one of liquid feeding steps of supplying a liquid among fluids, and is one of reagent steps of supplying a reagent containing no measurement target among liquids. The step A is a liquid feeding step which is executed before the next step of supplying a gas such as the step B. In this manner, the liquid feeding step executed before the next step of supplying a gas is also referred to as a previous step.

In step S33, the supply controller 41 executes the second step of supplying a gas to the sensor. For example, the supply controller 41 may execute the step B of supplying air to the sensor unit 23 as the second step. The step B is a step of supplying a gas, which is executed after the liquid feeding step. As described above, the step of supplying a gas, which is executed after the liquid feeding step as the previous step, is also referred to as a next step.

In step S34, the supply controller 41 executes the third step of supplying the second liquid to the sensor. For example, the supply controller 41 may execute, as the second step, the step C of supplying the specimen liquid as the second liquid to the sensor unit 23. The step C is one of liquid feeding steps of supplying a liquid among fluids, and is a specimen liquid step of supplying a specimen liquid containing a measurement target among liquids. The step C is a liquid feeding step which is executed before the step D for supplying the gas, and the step C can be referred to as a previous step and the step D can be referred to as a next step.

In step S35, the supply controller 41 executes the step D of supplying a gas to the sensor. When the step C immediately before the step D is defined as the first step and the step E subsequent to the step D is defined as the third step, the step D can be regarded as the second step.

In step S36, the supply controller 41 may further execute a step of supplying a fluid to the sensor unit 23. For example, the supply controller 41 may execute the step E of supplying a cleaning liquid from the second holding section 212 to the sensor unit 23. The step E is one of liquid feeding steps of supplying a liquid among the fluids, and is one of reagent steps of supplying a reagent that does not contain a measurement target among liquids. When the liquid feeding step before the step E, that is, the step C is defined as the first step, the step E, which is executed next after the step D, can be regarded as the third step.

In the present embodiment, the channel 28 of the cartridge 2 can be filled with a gas such as air. For example, the supply controller 41 feeds the first liquid to the sensor unit 23 by pressing the first holding section 211 with the pressing portion 33. Thereafter, by continuing to press the first holding section 211 or starting to press the second holding section 212, the air filled in the channel 28 can be supplied to the sensor unit 23. Thereafter, the second liquid finished in the second holding section 212 can be supplied to the sensor unit 23 by continuing to press the second holding section 212. In this manner, the supply controller 41 can execute the step of supplying a gas between the liquid feeding step and the liquid feeding step.

According to the configuration and method described above, the gas is supplied to the sensor after the first liquid is supplied to the sensor and before the second liquid is supplied. Thus, the first liquid staying on the sensor surface is pushed out and discharged by the gas supplied later. The second liquid is then supplied so as to reach the sensor surface. Therefore, the plurality of kinds of liquids can be sequentially supplied to the sensor without mixing the first liquid and the second liquid. As a result, the first liquid and the second liquid can be sequentially supplied to the sensor without being mixed with each other. If correct measurement is not performed when the liquids are mixed, such a malfunction can be avoided and the measurement can be correctly executed.

### Third Embodiment

Another embodiment of the present disclosure will be described below. Note that, for convenience of description, a member having the same function as that of a member described in the embodiments described above is denoted by the same reference sign, and description thereof will not be repeated.

In the present embodiment, the analysis device 1 described in the first embodiment is incorporated in the measuring device 3 of the measurement system 100. In the present embodiment, in the measurement system 100, the cartridge 2 described in the second embodiment may be employed as a configuration for implementing the channel 28 and the sensor unit 23 configured to detect the measurement target in the fluid in the channel 28. In the present embodiment, the controller 31 of the measuring device 3 may include the correction unit 44 and the concentration calculator 45 in addition to the extraction unit 42 and the determiner 43.

The correction unit 44 corrects the output signal OS analyzed by the concentration calculator 45 in order to calculate the concentration of the measurement target to an output signal more suitable for analysis. The correction unit 44 may correct the output signal OS itself, or may correct a feature extracted from the output signal OS. As an example, the correction unit 44 predicts a normal feature in the case of no measurement failure with respect to the feature of the output signal OS in the step in which it is determined that measurement failure occurs. The correction unit 44 may predict the normal feature on the basis of the feature observed in the normal period during which measurement failure has not occurred. Then, the correction unit 44 corrects the feature in the period during which measurement failure has occurred to the feature in the period during which measurement failure has not occurred. The corrected normal feature is supplied to the concentration calculator 45. The concentration calculator 45 can calculate the concentration of the measurement target on the basis of the feature corrected to the normal feature. A more detailed configuration of the correction unit 44 will be described below with a specific example.

Normal Model

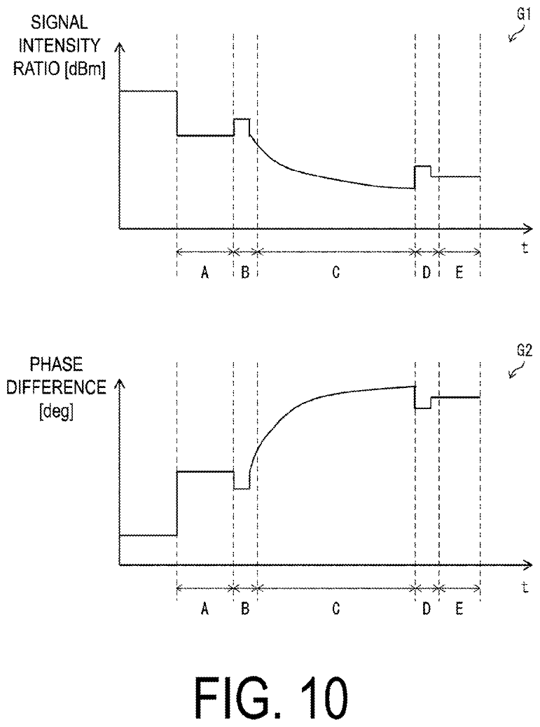

FIG. 10 is a graph illustrating an example of the normal model stored in the storage 32. Specifically, the graph illustrated in FIG. 10 illustrates an example of a feature that ideally changes for the output signal OS obtained when the measurement including a plurality of steps is normally performed. The two graphs illustrated in FIG. 10 illustrate an ideal transition of the feature over the entire step of measurement for the output signal OS obtained when the measurement method illustrated in FIG. 9 is normally performed. As an example, the feature may be a change amount of the output signal OS with respect to the input signal IS. More specifically, the change amount may be a signal intensity ratio (dBm) of the output signal OS with respect to the input signal IS, and particularly, may be an amplitude ratio (dBm). Alternatively, the change amount may be a phase difference (deg) of the output signal OS with respect to the input signal IS.

The graph G1 indicates the transition of the signal intensity ratio for each step expected to be obtained in the normal measurement when the feature is the signal intensity ratio (dBm) of the output signal OS with respect to the input signal IS. The graph G2 indicates the transition of the phase difference for each step expected to be obtained in the normal measurement when the feature is the phase difference (deg) of the output signal OS with respect to the input signal IS.

In this manner, the normal model to be stored in the storage 32 may be determined on the basis of the ideal transition of the feature over the entire step. For example, the prescribed amount that defines the normal model in the step A may be one or more threshold values for specifying the normal range of the signal intensity ratio that gradually decreases immediately after the step A is started.

Analysis Case

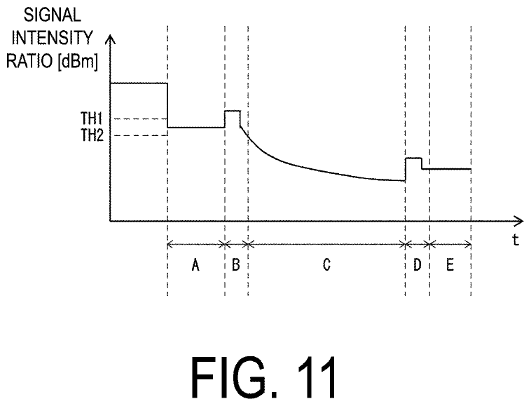

FIGS. 11 to 17 are diagrams illustrating a specific example of a feature analyzed by the analysis device 1 and a specific example of a prescribed amount compared with the feature. Hereinafter, by using specific examples illustrated in FIGS. 11 to 17, a method in which the analysis device 1 makes a predetermined determination regarding measurement, in particular, determines the presence or absence of measurement failure will be described in detail.

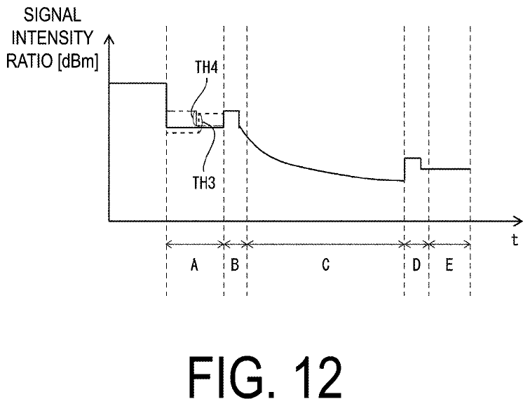

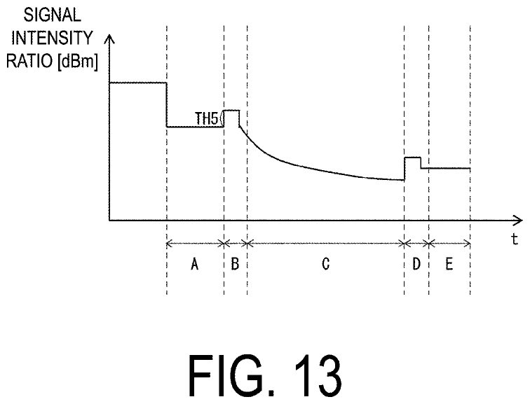

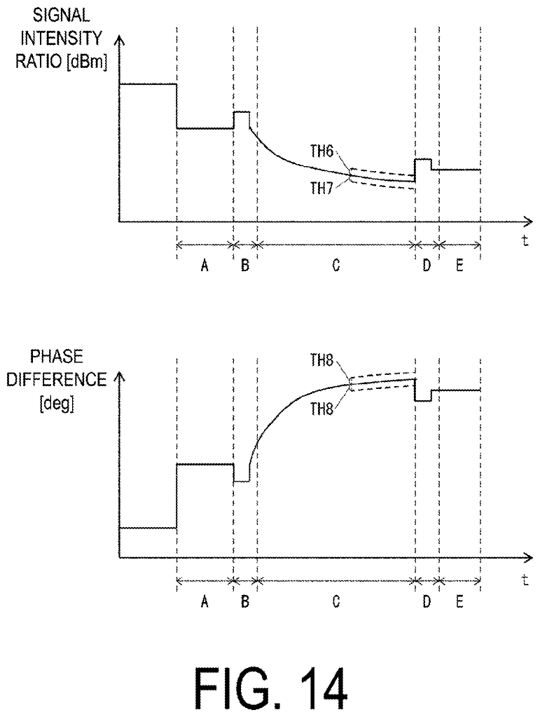

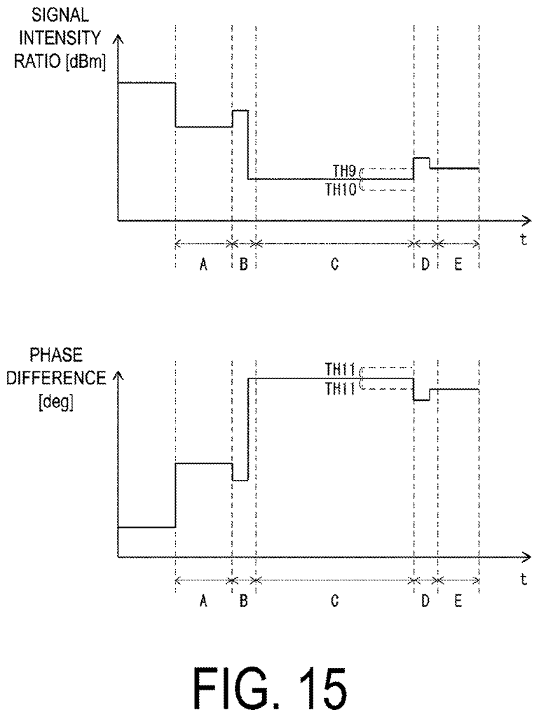

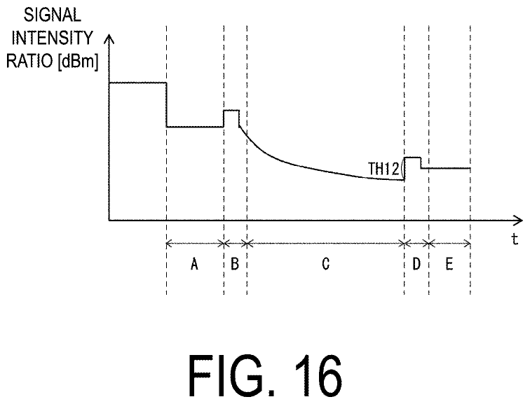

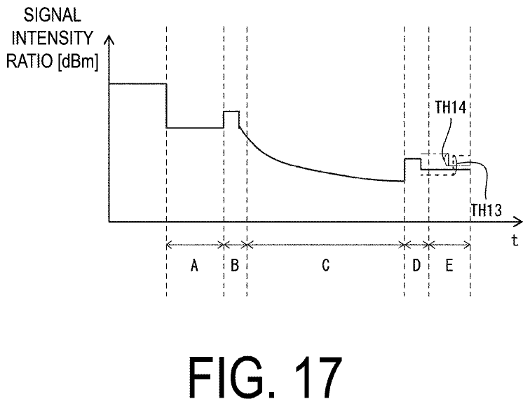

Hereinafter, as an example, a case where the analysis device 1 determines the presence or absence of measurement failure with respect to measurement including a plurality of steps (steps A to E) illustrated in FIG. 9 will be described. An example of the prescribed amount determined for each of the steps A to E is illustrated in the order of the steps in FIGS. 11 to 17. That is, FIG. 11 illustrates the prescribed amount of the step A, and FIG. 12 illustrates another prescribed amount of the step A. FIG. 13 illustrates the prescribed amount of the step B. FIG. 14 illustrates the prescribed amount of the step in which the fluid is supplied to the detector 24 in the step C, and FIG. 15 illustrates the prescribed amount of the step in which the fluid is supplied to the reference section 25 in the step C. FIG. 16 illustrates the prescribed amount of the step D. FIG. 17 illustrates the prescribed amount of the step E.

Case 1

As described above, the change amount may be the signal intensity ratio of the output signal OS with respect to the input signal IS. When the signal intensity ratio in the first step is equal to or greater than the first threshold value, the determiner 43 may determine that measurement failure due to air bubble adhesion has occurred in the first step. According to the configuration described above, in the first step, the presence or absence of measurement failure can be determined, and it can be determined that the cause of the measurement failure is air bubble adhesion.

When the signal intensity ratio in the first step is equal to or less than the second threshold value, the determiner 43 may determine that measurement failure due to a malfunction of the sensor has occurred in the first step. According to the configuration described above, in the first step, the presence or absence of measurement failure can be determined, and it can be determined that the cause of the measurement failure is a malfunction of the sensor unit 23.

As the malfunction of the sensor unit 23, for example, an element surface modification malfunction, an electrical contact malfunction, and the like are assumed. The element surface modification malfunction specifically refers to a malfunction in the formation of an organic film for binding an antibody on the surface of the detector 24 in the sensor unit 23. The electrical contact malfunction means a contact malfunction or the like of a connector portion that communicably connects the sensor unit 23 and the measuring device 3.

The first step described above may be, for example, the step A (FIG. 9) of supplying the calibration liquid to the sensor unit 23. FIG. 11 is a diagram illustrating an example of the prescribed amount defined for the analysis of Case 1 for the step A.

For example, the storage 32 may store a threshold value TH1 (first threshold value) as the prescribed amount of the step A. The threshold value TH1 is a threshold value indicating an upper limit of the normal range of the signal intensity ratio when the step A is executed. The normal range of the signal intensity ratio when the step A is executed may be defined as a range less than the threshold value TH1.

The determiner 43 can compare the signal intensity ratio of the output signal OS with respect to the input signal IS, which is observed during the period during which the step A is executed, with the threshold value TH1. When the signal intensity ratio in the step A is equal to or greater than the threshold value TH1, the determiner 43 may determine that measurement failure due to air bubble adhesion has occurred in the step A.

In order to obtain a correct measurement result, air bubbles desirably do not adhere to the detector 24 and the reference section 25 of the sensor unit 23 while the calibration liquid is fed in the step A. In this desirable situation, the signal intensity ratio is expected to decrease to less than the threshold value TH1 while the calibration liquid is flowing through the detector 24 and the reference section 25. When the signal intensity ratio does not decrease to less than the threshold value TH1, air bubbles may adhere to the detector 24 and the reference section 25 and the calibration liquid may not flow well on the surfaces of the detector 24 and the reference section 25.

As described above, the determiner 43 can determine the presence or absence of measurement failure due to air bubble adhesion of by comparing the signal intensity ratio in the step A with the threshold value TH1.

The storage 32 may further store a threshold value TH2 (second threshold value) as the prescribed amount of the step A. The threshold value TH2 is a threshold value indicating a lower limit of the normal range of the signal intensity ratio when the step A is executed. The normal range of the signal intensity ratio when the step A is executed may be defined as a range above the threshold value TH2.

The determiner 43 can compare the signal intensity ratio of the output signal OS with respect to the input signal IS, which is observed during the period during which the step A is executed, with the threshold value TH2. When the signal intensity ratio in the step A is equal to or less than the threshold value TH2, the determiner 43 may determine that measurement failure due to the malfunction of the sensor unit 23 has occurred in the step A.

In order to obtain a correct measurement result, it is desirable that the sensor unit 23 of the cartridge 2 and the signal processor 34 of the measuring device 3 be correctly connected to communicate with each other. It is desirable that an organic film for binding an antibody be correctly formed on the surface of the sensor unit 23. In this desirable situation, it is expected that the signal intensity ratio does not decrease to the threshold value TH2 or less while the calibration liquid is flowing through the detector 24 and the reference section 25. When the signal intensity ratio decreases to the threshold value TH2 or less, a correct output signal OS may not be obtained due to the element surface modification malfunction or the electrical contact malfunction.

As described above, the determiner 43 can determine the presence or absence of measurement failure due to the malfunction of the sensor unit 23 by comparing the signal intensity ratio in the step A with the threshold value TH2.

Case 2

The prescribed amount corresponds to one or more threshold values for specifying a specific range of a change in the feature per unit time as the specific model, and the determiner 43 may make a predetermined determination when the feature changes outside of the specific range in any unit time. According to the configuration described above, a predetermined determination regarding the measurement can be made on the basis of the transition of the feature in the execution period of the measurement. Specifically, a predetermined determination can be made on the basis of whether or not a steep increase or decrease is observed in the feature in the execution period of the measurement. The predetermined determination regarding the measurement on the basis of the transition of the feature in the execution period of the measurement may be made for the execution period of one step of the plurality of steps constituting the measurement. In this case, a predetermined determination can be made on the basis of whether or not the steep increase or decrease is observed in the feature in the execution period of the one step described above.

For example, the above-described specific model may be a normal model specified by a prescribed amount defined on the basis of an output signal when the output of the sensor unit 23 is normal, and the prescribed amount may be one or more threshold values indicating a normal range of a change per unit time of the feature. In this case, the determiner 43 may determine that measurement failure has occurred when the feature changes outside of a normal range specified by one or more threshold values per unit time. According to the configuration described above, the determiner 43 can determine that measurement failure has occurred in the measurement if a steep increase or decrease deviating from the normal range is observed in the feature in the execution period of the measurement. The above-described determination of the presence or absence of measurement failure may be made for the execution period of one step of the plurality of steps constituting the measurement. In this case, determination of the presence or absence of measurement failure for the one step can be made on the basis of whether or not a steep increase or decrease deviating from the normal range is observed in the feature in the execution period of the one step.

In the measurement system 100, regarding the measurement in which the supply controller 41 executes the step of supplying one or more kinds of fluids to the sensor unit 23 a plurality of times, the determiner 43 that makes a predetermined determination may be configured as follows.

The prescribed amount may be a third threshold value for specifying a specific range of a change in the feature per unit time as the specific model. The determiner 43 may make a predetermined determination when the feature in the liquid feeding step of supplying the liquid to the sensor unit 23 changes outside of the specific range specified by the third threshold value.

According to the configuration described above, the determiner 43 can make a predetermined determination regarding the measurement including the liquid feeding step when the feature changes outside of the specific range specified by the third threshold value in the execution period of the liquid feeding step. For example, the specific model may be a normal model, and the third threshold value may indicate a normal range of a change in the feature. In this case, the determiner 43 can determine that measurement failure has occurred in the liquid feeding step when the feature changes outside of the normal range indicated by the third threshold value in the execution period of the liquid feeding step.

Specifically, when the feature changes by a third threshold value or more per unit time in the liquid feeding step, the determiner 43 may determine that measurement failure has occurred in the period before the time point at which the above-described change has occurred or in the period after the time point at which the change has occurred in the liquid feeding step.

More specifically, the feature may be a change amount of the output signal OS from the input signal IS input to the sensor unit 23. Further, the change amount may be a signal intensity ratio of the output signal OS with respect to the input signal IS. When the signal intensity ratio in the liquid feeding step illustrates a stepwise increase, the determiner 43 may determine that measurement failure has occurred in a period after the time point at which the increase in the liquid feeding step is observed.

According to the configuration described above, the determiner 43 can determine the presence or absence of measurement failure in the liquid feeding step, and can also specify a period during which measurement failure has occurred during the liquid feeding step. Specifically, when a steep increase to a value equal to or greater than the third threshold value is observed from the transition of the signal intensity ratio in the execution period of the liquid feeding step, the determiner 43 can specify the period after the time point at which the increase is observed in the execution period of the liquid feeding step as the period during which measurement failure has occurred. As an example, the determiner 43 may specify a time point at which the signal intensity ratio rapidly increases as the time point at which the air bubbles adhere to the sensor unit 23.

Alternatively, when the signal intensity ratio in the liquid feeding step illustrates a stepwise decrease, the determiner 43 may determine that measurement failure has occurred in a period before the time point when the decrease in the liquid feeding step is observed.

According to the configuration described above, the determiner 43 can determine the presence or absence of measurement failure in the liquid feeding step, and can also specify a period during which measurement failure has occurred during the liquid feeding step. Specifically, when a steep decrease to a value equal to or greater than the third threshold value is observed from the transition of the signal intensity ratio in the execution period of the liquid feeding step, the determiner 43 can specify the period before the time point at which the decrease is observed in the execution period of the liquid feeding step as the period during which measurement failure has occurred. As an example, the determiner 43 may specify a time point at which the signal intensity ratio rapidly decreases as the time point at which the air bubbles separate from the sensor unit 23.

In order to obtain a correct measurement result, it is desirable that the liquid be supplied to the sensor unit 23 without being mixed with a foreign substance other than the liquid, for example, air bubbles, in the liquid feeding step of supplying the liquid to the sensor unit 23. In this desirable situation, it is expected that a steep change does not occur in the feature while the liquid flows through the sensor unit 23. When the feature changes by the third threshold value or more per unit time, a foreign substance such as air bubbles may be mixed in the liquid or a mixed foreign substance may be separated during the execution of the liquid feeding step.

As described above, the determiner 43 can determine the presence or absence of measurement failure due to mixing of a foreign substance such as air bubbles in the liquid feeding step by comparing the feature in the liquid feeding step with the third threshold value. Further, on the basis of the time point at which the steep increase or the steep decrease is observed, the period during which measurement failure has occurred can be specified among the periods during which the liquid feeding step has been executed.

The liquid feeding step described above may be, for example, the step A (FIG. 9) of supplying the calibration liquid to the sensor unit 23. FIG. 12 is a diagram illustrating an example of the prescribed amount defined for the analysis of Case 2 for the step A.

For example, the storage 32 may store a threshold value TH3 (third threshold value) as the prescribed amount of the step A. The threshold value TH3 is a threshold value indicating an upper limit of an increase amount per unit time of the signal intensity ratio (change amount) in the execution period of the step A. The normal range of the increase amount in the signal intensity ratio in the execution period of the step A may be defined as a range less than the threshold value TH3.

The determiner 43 analyzes the transition of the signal intensity ratio of the output signal OS with respect to the input signal IS observed in the execution period of the step A, and determines whether or not there is a time point of increase at which the increase amount per unit time is equal to or greater than the threshold value TH3. When the determiner 43 detects the above-described time point of increase, the determiner 43 determines that the air bubbles have adhered to the sensor unit 23 at the time point of increase. Then, the determiner 43 specifies a period after the above-described time point of increase in the execution period of the step A as a period during which measurement failure due to air bubble adhesion has occurred.

As described above, by comparing the increase amount in the signal intensity ratio in the step A with the threshold value TH3, the determiner 43 can determine the presence or absence of measurement failure due to air bubble adhesion, and can specify the period during which the measurement failure has occurred.

For example, the storage 32 may store a threshold value TH4 (third threshold value) as the prescribed amount of the step A. The threshold value TH4 is a threshold value indicating an upper limit of a decrease amount per unit time of the signal intensity ratio (change amount) in the execution period of the step A. The normal range of the decrease amount in the signal intensity ratio in the execution period of the step A may be defined as a range less than the threshold value TH4.

The determiner 43 analyzes the transition of the signal intensity ratio of the output signal OS with respect to the input signal IS observed in the execution period of the step A, and determines whether or not there is a time point of decrease at which the decrease amount per unit time is equal to or greater than the threshold value TH4. When the determiner 43 detects the above-described time point of decrease, the determiner 43 determines that the air bubbles are separated from the sensor unit 23 at the time point of decrease. Then, the determiner 43 specifies a period before the above-described time point of decrease in the execution period of the step A as a period during which measurement failure due to air bubble adhesion has occurred.

As described above, by comparing the decrease amount in the signal intensity ratio in the step A with the threshold value TH4, the determiner 43 can determine the presence or absence of measurement failure due to air bubble adhesion, and can specify the period during which the measurement failure has occurred.

The liquid feeding step described above may be, for example, the step C (FIG. 9) of supplying the specimen liquid to the sensor unit 23. FIG. 14 is a diagram illustrating an example of the prescribed amount defined for the analysis of Case 2 particularly in the step of supplying the specimen liquid to the detector 24 in the step C. Hereinafter, in the step C, the step of supplying the specimen liquid to the detector 24 is particularly referred to as a test step. A channel for transmitting the output signal OS output from the detector 24 to the signal processor 34 is referred to as a test channel.

For example, a threshold value TH6 (third threshold value) and a threshold value TH7 (third threshold value) may be stored in the storage 32 as the prescribed amount of the test step of the step C. The threshold value TH6 and the threshold value TH7 are threshold values indicating the upper limits of the range of change per unit time in the signal intensity ratio observed in the execution period of the test step. The threshold value TH6 is a threshold value indicating an upper limit of an increase amount in the signal intensity ratio observed in the execution period of the test step, and the threshold value TH7 is a threshold value indicating an upper limit of a decrease amount in the signal intensity ratio observed in the execution period of the test step. The normal range of the increase amount of the signal intensity ratio in the execution period of the test step may be defined as a range less than the threshold value TH6, and the normal range of the decrease amount may be defined as a range less than the threshold value TH7.

In another example, the extraction unit 42 may extract a phase difference (change amount) of the output signal OS with respect to the input signal IS as a feature, in addition to the signal intensity ratio. In this case, for example, the storage 32 may store a threshold value TH8 (third threshold value) as the prescribed amount of the test step. The threshold value TH8 is a threshold value indicating an upper limit of the change width per unit time of the phase difference in the execution period of the test step. The normal range of the change width of the phase difference in the execution period of the test step may be defined as being less than the threshold value TH8.

The “change” per unit time of the signal intensity ratio or the phase difference described above is intended to mean a stepwise rapid change, and is different from a gradual change (the curve illustrated in FIG. 14) associated with the reaction of the measurement target in the specimen liquid with the reactant on the surface of the detector 24.

The determiner 43 analyzes the transition of the signal intensity ratio observed in the execution period of the test step, and determines whether or not there is a time point of increase at which the increase amount per unit time is equal to or greater than the threshold value TH6. The determiner 43 determines whether or not there is a time point of decrease at which the decrease amount per unit time is equal to or greater than the threshold value TH7. As in the case of the step A, the determiner 43 determines the presence or absence of the measurement failure due to air bubble adhesion on the basis of the presence or absence of the time point of increase or the presence or absence of the time point of decrease, and specifies the period during which the measurement failure has occurred.

As described above, by comparing the increase amount in the signal intensity ratio in the test step with the threshold value TH6, the determiner 43 can determine the presence or absence of the measurement failure due to air bubble adhesion, and can specify the period during which the measurement failure has occurred.

By comparing the decrease amount in the signal intensity ratio in the test step with the threshold value TH7, the determiner 43 can determine the presence or absence of measurement failure due to air bubble adhesion, and can specify the period during which the measurement failure has occurred.

Furthermore, by comparing the change width in phase difference in the test step with the threshold value TH8, the determiner 43 can determine the presence or absence of measurement failure due to air bubble adhesion, and can specify the period during which the measurement failure has occurred. Specifically, the determiner 43 can specify a period during which the above-described measurement failure has occurred, depending on whether a time point at which a steep change in the phase difference is observed is the time point of increase or the time point of decrease.

FIG. 15 is a diagram illustrating an example of the prescribed amount defined for the analysis of Case 2 particularly for the step of supplying the specimen liquid to the reference section 25 in the step C. Hereinafter, the step of supplying the specimen liquid to the reference section 25 in the step C is particularly referred to as a reference step. A channel for transmitting the output signal OS output from the reference section 25 to the signal processor 34 is referred to as a reference channel.

For example, a threshold value TH9 (third threshold value) and a threshold value TH10 (third threshold value) may be stored in the storage 32 as the prescribed amount of the reference step of the step C. The threshold value TH9 is a threshold value indicating an upper limit of an increase amount in the signal intensity ratio observed in the execution period of the reference step, and the threshold value TH10 is a threshold value indicating an upper limit of a decrease amount in the signal intensity ratio observed in the execution period of the reference step. The normal range of the increase amount of the signal intensity ratio in the execution period of the reference step may be defined as a range less than the threshold value TH9, and the normal range of the decrease amount may be defined as a range less than the threshold value TH10. Further, the storage 32 may further store a threshold value TH11 (third threshold value) as the prescribed amount of the reference step. The threshold value TH11 is a threshold value indicating an upper limit of the change width in the phase difference observed in the execution period of the reference step. The normal range of the change width in the phase difference observed in the execution period of the reference step may be defined as being less than the threshold value TH11.

Since the reactant is not provided on the surface of the reference section 25, a gradual change in the change amount as in the test step is not observed. Except that a gradual change is not observed, similar to the test step, the determiner 43 can determine the presence or absence of measurement failure and specify a period during which the measurement failure has occurred on the basis of a steep change in the change amount in the reference step.

The liquid feeding step described above may be, for example, the step E (FIG. 9) of supplying the cleaning liquid to the sensor unit 23. FIG. 17 is a diagram illustrating an example of the prescribed amount defined for the analysis of Case 2 for the step E.

For example, a threshold value TH13 (third threshold value) and a threshold value TH14 (third threshold value) may be stored in the storage 32 as the prescribed amount of the step E. The threshold value TH13 is a threshold value indicating an upper limit of an increase amount in the signal intensity ratio observed in the execution period of the step E, and the threshold value TH14 is a threshold value indicating an upper limit of a decrease amount in the signal intensity ratio observed in the execution period of the step E. The normal range of the increase amount of the signal intensity ratio in the execution period of the step E may be defined as a range less than the threshold value TH13, and the normal range of the decrease amount may be defined as a range less than the threshold value TH14.

The determiner 43 analyzes the transition of the signal intensity ratio observed in the execution period of the step E, and determines whether or not there is a time point of increase at which the increase amount per unit time is equal to or greater than the threshold value TH13. The determiner 43 determines whether or not there is a time point of decrease at which the decrease amount per unit time is equal to or greater than the threshold value TH14. As in the case of the step A and the step C, the determiner 43 determines the presence or absence of measurement failure due to air bubble adhesion on the basis of the presence or absence of the time point of increase or the presence or absence of the time point of decrease, and specifies a period during which the measurement failure has occurred.

Case 3

The liquid feeding step of supplying the liquid to the sensor unit 23 may be, for example, a reagent step of supplying a reagent containing no measurement target to the sensor unit 23. As the reagent, for example, a calibration liquid, a cleaning liquid, and the like can be assumed. In the example illustrated in FIG. 9, the step A of supplying the calibration liquid to the sensor unit 23 is an example of a reagent step. The step E of supplying the cleaning liquid to the sensor unit 23 is an example of a reagent step.

In the present embodiment, the controller 31 of the measuring device 3 may include the correction unit 44 and the concentration calculator 45. The correction unit 44 corrects the feature in the period during which measurement failure has occurred in the reagent step to the feature in the period during which the measurement failure has not occurred.

According to the configuration described above, even when measurement failure (for example, measurement failure due to air bubble adhesion) occurs in the reagent step, the feature of the period during which measurement failure has occurred can be supplemented on the basis of the feature of the period during which measurement failure has not occurred. By performing the concentration calculation using the feature corrected in this manner, a highly reliable measurement result can be output without performing re-measurement. As a result, time and effort for re-measurement can be reduced.

For example, it is assumed that the determiner 43 detects an increase of the signal intensity ratio equal to or more than the threshold value TH3 (FIG. 12) at the time point T in the execution period of the step A by the analysis of the above-described case 2. The determiner 43 specifies a period after the time point of increase T in the execution period of the step A as a period during which measurement failure due to air bubble adhesion has occurred.

On the basis of the determination result, the correction unit 44 corrects the signal intensity ratio in the period after the time point of increase T to the signal intensity ratio in the period before the time point of increase T, that is, the period during which the above-described measurement failure has not occurred.

The transition of the signal intensity ratio in the step A, which is obtained by the above-described correction by the correction unit 44, is considered to indicate the transition of the signal intensity ratio which would be obtained when measurement failure due to air bubble adhesion has not occurred.

The concentration calculator 45 calculates the concentration of the measurement target contained in the specimen P on the basis of the transition of the signal intensity ratio after the correction.

Case 4

As described above, the sensor unit 23 includes the detector 24 (first sensor) to which the reactant reacting with the measurement target is fixed and the reference section 25 (second sensor) to which the reactant is not fixed. The detector 24 outputs a measurement signal as the output signal OS transmitted through the test channel. The reference section 25 outputs a reference signal as the output signal OS transmitted through the reference channel.

The liquid feeding step of supplying the liquid to the sensor unit 23 may be, for example, a specimen liquid step of supplying a specimen liquid containing a measurement target to the detector 24 and the reference section 25. In the example illustrated in FIG. 9, the step C of supplying the specimen liquid containing the measurement target to the sensor unit 23 is an example of a specimen liquid step.

When the determiner 43 determines that the reference feature extracted from the reference signal deviates from the normal model and the measurement feature extracted from the measurement signal does not deviate from the normal model, the concentration calculator may calculate the measurement result on the basis of the measurement feature without using the reference feature.

When the reference signal of the reference channel output from the reference section is referenced, the reliability of the measurement result can be improved as compared with the case of calculating the measurement result only from the measurement signal of the test channel output from the detector 24. In such a configuration, when the measurement failure (for example, the measurement failure due to air bubble adhesion) occurs only in the reference section 25, the concentration calculator 45 calculates the measurement result on the basis of the measurement signal of the detector 24 in which measurement failure has not occurred. Thus, even if measurement failure occurs in the reference section 25, measurement can be continued while ensuring reliability on the basis of the measurement signal output from the detector 24. As a result, time and effort for re-measurement can be reduced.

Case 5

As described above, the measurement system 100 may further include the supply controller 41 that supplies one or more kinds of liquids and gases to the sensor unit 23. The supply controller 41 may be provided in the controller 31 of the measuring device 3.

In this case, the feature may be a change amount of the output signal OS from the input signal IS input to the sensor unit 23. The prescribed amount may be a threshold value for specifying the range of the difference between the change amount in the previous step and the change amount in the next step as the specific model.

The determiner 43 may make a predetermined determination when the difference between the first change amount in the previous step in which the liquid is supplied to the sensor and the second change amount in the next step in which the gas is supplied to the sensor is less than a fourth threshold value for the next step.

According to the configuration described above, a predetermined determination can be made with respect to the step of supplying a gas, that is, the next step, which is executed between the liquid feeding step and the liquid feeding step. For example, when the specific model is a normal model specified by the fourth threshold value indicating the normal range of the difference described above, the determiner 43 can determine the presence or absence of measurement failure due to the gas not being able to be supplied. The above-described measurement failure is, for example, measurement failure in which two liquids supplied in the liquid feeding steps immediately before and after the next step are mixed because the gas is not sandwiched therebetween, and thus an appropriate feature cannot be obtained.

The above-described next step may be, for example, the step B (FIG. 9) executed next to the step A which is the liquid feeding step. FIG. 13 is a diagram illustrating an example of the prescribed amount defined for the analysis of Case 5 for the step B. For example, the storage 32 may store a threshold value TH5 (fourth threshold value) as the prescribed amount of the step B. The threshold value TH5 is a threshold value indicating the normal range of the difference between the signal intensity ratio (change amount) in the step A as the previous step and the signal intensity ratio in the step B as the next step. The normal range of the difference between the signal intensity ratio in the step A and the signal intensity ratio in the step B may be defined as being equal to or greater than the threshold value TH5.

The determiner 43 analyzes the transition of the signal intensity ratio of the output signal OS with respect to the input signal IS observed during the transition period from the step A to the step B, and determines whether or not the difference between the signal intensity ratio of the step A and the signal intensity ratio of the step B is equal to or greater than the threshold value TH5. The determiner 43 determines that the gas has not been supplied to the sensor unit 23 as intended when the above-described difference is less than the threshold value TH5. Then, the determiner 43 determines that measurement failure may have occurred due to mixing of the liquids supplied in the liquid feeding steps before and after the step B, that is, the step A and the step C, respectively, because the gas has not been supplied.

As described above, by comparing the difference between the signal intensity ratio in the step B and the signal intensity ratio in the step A with the threshold value TH5, the determiner 43 can determine the presence or absence of measurement failure due to mixing of the liquids fed in the previous and subsequent liquid feeding steps.

The above-described next step may be, for example, the step D (FIG. 9) executed next to the step C which is the liquid feeding step. FIG. 16 is a diagram illustrating an example of the prescribed amount defined for the analysis of Case 5 for the step D.

For example, the storage 32 may store a threshold value TH12 (fourth threshold value) as the prescribed amount of the step D. The threshold value TH12 is a threshold value indicating the normal range of the difference between the signal intensity ratio (change amount) in the previous step C, particularly immediately before the end of the step C, and the signal intensity ratio in the next step D, which is the next step. The normal range of the difference between the signal intensity ratio in the step C and the signal intensity ratio in the step D may be defined as being equal to or greater than the threshold value TH12.

The determiner 43 analyzes the transition of the signal intensity ratio of the output signal OS with respect to the input signal IS observed during the transition period from the step C to the step D, and determines whether or not the difference between the signal intensity ratio of the step C and the signal intensity ratio of the step D is equal to or greater than the threshold value TH12. The determiner 43 determines that the gas has not been supplied to the sensor unit 23 as intended when the above-described difference is less than the threshold value TH12. Then, the determiner 43 determines that measurement failure may have occurred due to mixing of the liquids supplied in the liquid feeding steps before and after the step D, that is, the step C and the step E, respectively, because the gas has not been supplied.

As described above, by comparing the difference between the signal intensity ratio in the step D and the signal intensity ratio in the step C with the threshold value TH12, the determiner 43 can determine the presence or absence of measurement failure due to mixing of the liquids fed in the previous and subsequent liquid feeding steps.

Example of Software Implementation

The functions of the analysis device or the measuring device (hereinafter, referred to as a “device”) can be implemented by a program for causing a computer to function as the device, that is, a program for causing a computer to function as each control block (particularly, each unit included in the controller 31) of the device.

In this case, the apparatus includes a computer having at least one control device (for example, a processor) and at least one storage device (for example, a memory) as hardware for executing the program. By executing the program by the control device and the storage device, each function described in each of the embodiments is implemented.

The program may be recorded in one or more non-transitory computer-readable recording media. The recording medium may or may not be included in the apparatus. In the latter case, the program may be supplied to the device via any wired or wireless transmission medium.

Some or all of the functions of the control blocks may be implemented by a logic circuit. For example, an integrated circuit in which a logic circuit functioning as each of the control blocks is formed is also included in the scope of the present disclosure. In addition, for example, the functions of the control blocks can be implemented by a quantum computer.

Each process described in each of the above-described embodiments may be executed by artificial intelligence (AI). In this case, the AI may be operated by the control device or may be operated by another device (for example, an edge computer, a cloud server, or the like).

In the present disclosure, the invention has been described above on the basis of the various drawings and examples. However, the invention according to the present disclosure is not limited to each embodiment described above. That is, the embodiments of the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, a person skilled in the art can easily make various variations or modifications on the basis of the present disclosure. Note that these variations or modifications are included within the scope of the present disclosure.

### REFERENCE SIGNS

1 Analysis device
2 Cartridge (channel device)
3 Measuring device
21 Holding section (first container, second container)
22 Liquid receiving section (first container, second container)
23 Sensor unit (sensor)
24 Detector (sensor, first sensor)
25 Reference section (sensor, second sensor)
28 Channel
31 Controller
32 Storage
33 Pressing portion
34 Signal processor
35 Display
36 Communicator
41 Supply controller
42 Extraction unit
43 Determiner
44 Correction unit
45 Concentration calculator (calculator, concentration calculator)
100 Measurement system
211 First holding section (first container, second container)
212 Second holding section (first container, second container)

1. A measurement system comprising:
a channel;
a sensor located in the channel and configured to detect a measurement target in a fluid;
an extraction unit configured to extract at least one feature from an output signal output from the sensor;
a storage configured to store a specific model that is defined based on a specific output from the sensor; and
a determiner configured to make a predetermined determination when one or more features of the at least one feature deviate from the specific model.

2. The measurement system according to claim 1, wherein
the specific model is specified by a prescribed amount that is defined based on the output signal when an output of the sensor is in a specific state.

3. The measurement system according to claim 2, wherein
the at least one feature is a change amount of the output signal from an input signal input to the sensor.

4. The measurement system according to claim 3, further comprising:
a supply controller configured to supply one or more kinds of fluids to the sensor, wherein
the prescribed amount corresponds to one or more threshold values for specifying a specific range of the at least one feature as the specific model, and
the determiner is configured to make the predetermined determination when the change amount in a first step in which a first fluid is supplied to the sensor deviates from the specific range specified by the one or more threshold values for the first step.

5. The measurement system according to claim 4, wherein
the specific model is a normal model specified by a prescribed amount that is defined based on the output signal when an output of the sensor is in a pre-defined normal range, and
the determiner is configured to determine that measurement failure occurs when the one or more features of the at least one feature deviate from the normal model.

6. The measurement system according to claim 5, wherein
the change amount is a signal intensity ratio of the output signal to the input signal, and
the determiner is configured to determine that measurement failure due to air bubble adhesion occurs in the first step when the signal intensity ratio in the first step is equal to or greater than a first threshold value.

7. The measurement system according to claim 5, wherein
the change amount is a signal intensity ratio of the output signal to the input signal, and
the determiner is configured to determine that measurement failure due to a malfunction of the sensor occurs in the first step when the signal intensity ratio in the first step is equal to or less than a second threshold value.

8. The measurement system according to claim 2, wherein
the prescribed amount corresponds to one or more threshold values for specifying a specific range of a change in the at least one feature per unit time as the specific model, and
the determiner is configured to make a predetermined determination when the at least one feature changes outside of the specific range in any unit time.

9. The measurement system according to claim 8, further comprising:
a supply controller configured to supply one or more kinds of fluids to the sensor, wherein
the prescribed amount is a third threshold value for specifying the specific range of the change in the at least one feature per unit time as the specific model, and
the determiner is configured to make the predetermined determination when the at least one feature in a liquid feeding step, in which the supply controller supplies a liquid to the sensor, changes outside of the specific range specified by the third threshold value.

10. The measurement system according to claim 9, wherein
the specific model is a normal model specified by a prescribed amount defined based on the output signal when an output of the sensor is in a pre-defined normal range, and
the determiner is configured to determine that measurement failure occurs when the one or more features of the at least one feature deviate from the normal model.

11. The measurement system according to claim 10, wherein,
in the liquid feeding step, the determiner is configured to determine that the measurement failure occurs in a period before a time point of the change or after a time point of the change in the liquid feeding step when the at least one feature changes by the third threshold value or more per unit time.

12. The measurement system according to claim 11, wherein
the at least one feature is a change amount of the output signal from an input signal input to the sensor,
the change amount is a signal intensity ratio of the output signal to the input signal, and
the determiner is configured to, when the signal intensity ratio in the liquid feeding step indicates a stepwise increase, determine that the measurement failure occurs in a period after a time point at which the increase in the liquid feeding step is observed.

13. The measurement system according to claim 8, wherein
the at least one feature is a change amount of the output signal from an input signal input to the sensor,
the change amount is a signal intensity ratio of the output signal to the input signal, and
the determiner is configured to, when the signal intensity ratio in a liquid feeding step of supplying a liquid to the sensor indicates a stepwise decrease, determine that the measurement failure occurs in a period before a time point at which the decrease in the liquid feeding step is observed.

14. The measurement system according to claim 10, wherein
a liquid feeding step in which the supply controller supplies a liquid to the sensor is a reagent step in which the supply controller supplies a reagent containing no measurement target to the sensor, and
the measurement system further comprises a correction unit configured to correct the at least one feature in a period during which the measurement failure occurs in the reagent step to the at least one feature in a period during which the measurement failure does not occur.

15. The measurement system according to claim 10, wherein
the sensor comprises a first sensor to which a reactant that reacts with the measurement target is fixed for outputting a measurement signal, and a second sensor to which the reactant is not fixed for outputting a reference signal,
the liquid feeding step is a specimen liquid step in which the supply controller supplies a specimen liquid containing the measurement target to the first sensor and the second sensor, and
the measurement system comprises a calculator configured to calculate a measurement result based on a measurement feature without using a reference feature when the determiner determines that the reference feature extracted from the reference signal deviates from the normal model and the measurement feature extracted from the measurement signal does not deviate from the normal model.

16. The measurement system according to claim 3, further comprising a supply controller configured to supply one or more kinds of liquids and gases to the sensor, wherein
the at least one feature is a change amount of the output signal from an input signal input to the sensor,
the prescribed amount is a threshold value for specifying, as the specific model, a range of a difference between the change amount in a previous step and the change amount in a next step, and
the determiner is configured to make a predetermined determination when the difference between a first change amount in the previous step in which a liquid is supplied to the sensor and a second change amount in the next step in which a gas is supplied to the sensor is less than a fourth threshold value for the next step.

17. The measurement system according to claim 1, comprising a measuring device comprising a supply controller configured to supply one or more kinds of fluids to the sensor, wherein
the supply controller is configured to execute:
a first step of supplying a first liquid to the sensor;
a second step of supplying a gas to the sensor after the first step; and
a third step of supplying a second liquid to the sensor after the second step.

18. The measurement system according to claim 17, further comprising a channel device connected to the measuring device, wherein
the channel device comprises:
a first container configured to accommodate a first liquid;
a second container configured to accommodate a second liquid;
the sensor; and
the channel from the first container and the second container to the sensor, and
the supply controller of the measuring device is configured to execute the first step, the second step, and the third step after the channel device is connected to the measuring device.

19. A non-transitory computer-readable recording medium that stores an analysis program, the analysis program configured to function as the extraction unit and the determiner of the measurement system according to claim 1.

20. A measurement method for measuring a measurement target contained in a fluid, the measurement method comprising:
supplying a first liquid to a sensor;
supplying a gas to the sensor after supplying the liquid;
supplying a second liquid to the sensor after supplying the gas, and
analyzing an output signal output from the sensor configured to detect the measurement target in the fluid.
